(19) United States
(12) Patent Application Publication
(10) Pub. No.: US 2025/0148676 A1
(43) Pub. Date: May 8, 2025

(54) Method and Apparatus for the Acquisition, Storage and Display of Three-Dimensional Videos at Variable Frame Rates

(71) Applicant: Cinemersive Labs Ltd, Ruislip (GB)

(72) Inventors: Victor Lempitskiy, Edinburgh (GB); Kirill Dmitrenko, Edinburgh (GB); Anuar Taskynov, Edinburgh (GB)

(21) Appl. No.: 18/937,257

(22) Filed: Nov. 5, 2024

Related U.S. Application Data
(60) Provisional application No. 63/596,382, filed on Nov. 6, 2023.

(51) Int. Cl. G06T 13/20; G06T 15/04; G06T 17/20

(52) U.S. Cl. CPC G06T 13/20; G06T 15/04; G06T 17/205

(57) ABSTRACT

Systems and methods for displaying a three-dimensional video at a different frame rate from which the video was stored or acquired are described. In one aspect, a frame N corresponding to a frame number N in the video is received at a video reader and decoder. A 3D mesh including a plurality of vertices, a texture, and one or more offset vectors associated with each vertex of the 3D mesh in the frame N are retrieved and transmitted to a rendering device. At least one vertex of the 3D mesh is adjusted according to the corresponding offset vectors and a playback time moment. The playback time moment is between N and N+1, where N+1 is a frame number corresponding to a frame N+1 immediately following the frame N. The adjusted 3D mesh and the texture are rendered according to one or more camera parameters associated with a display device.

### RELATED APPLICATION

This application claims the priority benefit of U.S. Provisional Application Ser. No. 63/596,382, entitled “Method and System for Three-Dimensional Scene Models”, filed Nov. 6, 2023, the disclosure of which is incorporated by reference herein in its entirety.

### BACKGROUND

### Technical Field

The present disclosure relates to systems and methods for the acquisition, storage and display of three-dimensional videos when an associated display device has a different frame rate from the frame rate at which the three-dimensional video is acquired and stored.

### Background Art

Three-dimensional videos are an emerging new media modality. The term “three-dimensional video” can be generally understood to describe a video where each frame is a 3D model. In different contexts, variants of such videos are sometimes called free-viewpoint videos, volumetric videos or immersive videos. Acquiring, storing, transmitting, and displaying three-dimensional videos pose multiple challenges.

### Acquisition of Three-Dimensional Videos

Typically, there are two alternative ways in which three-dimensional videos can be acquired. Firstly, they can be captured from reality using stereo camera setups and processing the input from such setups using computer vision algorithms. Secondly, three-dimensional videos can be generated (synthesized) using computer animation tools, so that the objects of the scene and their motion trajectories are defined by 3D designers, and the resulting video is produced by a dedicated computer graphics software.

Once acquired, three-dimensional videos are stored on a storage device (usually after being compressed using lossy or lossless compression algorithms). The stored videos can then be transmitted as a whole or streamed over computer networks. Three-dimensional videos can then be displayed using three-dimensional display devices, such as virtual reality headsets, augmented reality glasses, volumetric displays, or standard flat screen displays.

### 3D Representations and Video Formats

Different systems use different approaches to represent three-dimensional models that constitute individual frames of a three-dimensional video. One approach is to represent individual frames as textured triangular meshes. In this approach, the surface geometry at each frame is defined by a triangular mesh outlining surfaces that are present in the scene, while the properties of the said surfaces such as color, surface semi-transparency, surface specularity, etc. are stored in flat two-dimensional texture maps. Separate compression algorithms (e.g., codecs) can be applied to the stream of surface meshes and to the stream of textures. There are several alternative approaches to how three-dimensional frames can be represented, including point clouds, implicit neural representations, voxel arrays, etc.

### Three-Dimensional Video Framerates

A key challenge lies in the fact that the framerate at which a three-dimensional video is acquired and the framerate at which the video needs to be displayed can be different. Such a frame rate mismatch is inevitable in many circumstances. Frame rates at which three-dimensional videos are acquired and stored can be limited by the frame rate of stereo camera setups, by the computational resources needed for stereo matching or computer animation, as well as by the need to store or transmit such three-dimensional videos under constraints on the storage size or on the network bandwidth.

On the other hand, most three-dimensional display devices require the display framerate to be high enough to ensure a comfortable viewing experience. In particular, virtual reality headsets require videos to be played at high frame rates, typically 72 frames per second or more. Also, it is very common that the intended display framerate is unknown at the time of video acquisition. The same video can be intended for different 3D display devices with different supported frame rates.

### Three-Dimensional Frame Interpolation

It is common to have a situation when the video is acquired and stored at a lower framerate (e.g. 25 or 30 frames per second), whereas a higher framerate (e.g. 72, 90, or 120 frames per second) is needed for display. To address this challenge, a method needs to be provided to create three-dimensional models of the frames that correspond to intermediate time moments that lie in-between time moments that correspond to frames in the stored videos. This is known as the frame interpolation task.

To do frame interpolation, one can use so-called nearest interpolation, i.e. use the three-dimensional model of the frame that is either closest in time or (in case of sequential reading/transmission) of the frame that precedes the considered time moment and is stored in the video. This, however, leads to jerky playback and the loss of visual comfort for the observer, especially when a virtual reality headset is used for display.

To provide smooth playback without jerks, a method is required to estimate geometry and all the texture maps at a particular point in time using a subset of frames of the stored video.

One such algorithm is linear interpolation. This approach has drawbacks. Firstly, linearly interpolating the texture maps may produce noticeably incorrect results, particularly if the texture map stream contains many moving parts. Also, it requires significant additional computational resources for high-fidelity texture maps. Techniques that can produce more precise results can be cost-prohibitive, especially on currently available consumer devices. Secondly, linear interpolation can only be applied if texture mappings of subsequent frames are compatible with each other, which is usually not the case for all frames in the video. Thirdly, linear interpolation requires reading and holding in memory of at least two frames.

Alternatively, one can use some form of motion vectors defined by the mesh geometry codec for mesh vertices. This has several drawbacks as well. First, not all codecs define motion vectors for every vertex in every frame. In particular, the two adjacent frames may have very different meshes of different topologies, and the motion vectors between the two may be undefined. Secondly, the motion vectors determined by the mesh geometry codec do not take texture changes into account, which may result in artifacts during interpolation.

### SUMMARY

In one embodiment of the present invention, a set of interpolation parameters is stored for every mesh vertex in each of the video frames, such that the set of said parameters allows an associated system to obtain one or more three-dimensional models at intermediate time moments between frames via an interpolation procedure. In an aspect, the interpolation procedure uses the position of the vertex mesh, the set of interpolation parameters, and the time moment in order to predict an interpolated position of each vertex of the mesh at a given time instant.

In another embodiment, the ability to obtain the three-dimensional models at intermediate time moments is used to display a three-dimensional video at a higher or different frame rate, as compared to the frame rate at which the video was acquired and stored. The three-dimensional video may be rendered to a user smoothly, without any jitter or visual discomfort.

In another embodiment, the interpolation parameters are estimated after the three-dimensional video has been acquired, via a numerical minimization of any mismatch between subsequent frames. This mismatch may be measured between the later frames and the earlier frame after each vertex of the earlier frame undergoes the interpolation procedure with times corresponding to the later frames.

In another embodiment of the present invention, the interpolation parameters are predicted after the three-dimensional video has been acquired via the application of a trained neural network that is trained on subsets of frames to predict interpolation parameters that would minimize the mismatch.

In another embodiment of the present invention, the mismatch is measured by comparing two-dimensional images obtained by the projections of the later frame and the earlier frame via the mesh rendering process, once the vertices of the earlier frame have undergone the interpolation procedure, whereas the texture of the earlier frame remains unmodified.

In another embodiment of the present invention, the interpolation parameters stored at each mesh vertex have the form of a three-dimensional offset vector that can be interpolated linearly based on the time moment, and added to the vertex position.

### BRIEF DESCRIPTION OF THE DRAWINGS

Non-limiting and non-exhaustive embodiments of the present disclosure are described with reference to the following figures, wherein like reference numerals refer to like parts throughout the various figures unless otherwise specified.

FIG. 1 is a block diagram of a system configured to process and display a three-dimensional video.

FIG. 2 is a timing diagram associated with a frame interpolation process.

FIG. 3 is a process flow for estimating one or more offset vectors from two subsequent frames using an optimization framework.

FIG. 4 is a process flow for offset vector estimation based on differentiable rendering.

### DETAILED DESCRIPTION

In the following description, reference is made to the accompanying drawings that form a part thereof, and in which is shown by way of illustration specific exemplary embodiments in which the disclosure may be practiced. These embodiments are described in sufficient detail to enable those skilled in the art to practice the concepts disclosed herein, and it is to be understood that modifications to the various disclosed embodiments may be made, and other embodiments may be utilized, without departing from the scope of the present disclosure. The following detailed description is, therefore, not to be taken in a limiting sense.

Reference throughout this specification to “one embodiment,” “an embodiment,” “one example,” or “an example” means that a particular feature, structure, or characteristic described in connection with the embodiment or example is included in at least one embodiment of the present disclosure. Thus, appearances of the phrases “in one embodiment,” “in an embodiment,” “one example,” or “an example” in various places throughout this specification are not necessarily all referring to the same embodiment or example. Furthermore, the particular features, structures, databases, or characteristics may be combined in any suitable combinations and/or sub-combinations in one or more embodiments or examples. In addition, it should be appreciated that the figures provided herewith are for explanation purposes to persons ordinarily skilled in the art and that the drawings are not necessarily drawn to scale.

Embodiments in accordance with the present disclosure may be embodied as an apparatus, method, or computer program product. Accordingly, the present disclosure may take the form of an entirely hardware-comprised embodiment, an entirely software-comprised embodiment (including firmware, resident software, micro-code, etc.), or an embodiment combining software and hardware aspects that may all generally be referred to herein as a “circuit,” “module,” or “system.” Furthermore, embodiments of the present disclosure may take the form of a computer program product embodied in any tangible medium of expression having computer-usable program code embodied in the medium.

Any combination of one or more computer-usable or computer-readable media may be utilized. For example, a computer-readable medium may include one or more of a portable computer diskette, a hard disk, a random-access memory (RAM) device, a read-only memory (ROM) device, an erasable programmable read-only memory (EPROM or Flash memory) device, a portable compact disc read-only memory (CDROM), an optical storage device, a magnetic storage device, and any other storage medium now known or hereafter discovered. Computer program code for carrying out operations of the present disclosure may be written in any combination of one or more programming languages. Such code may be compiled from source code to computer-readable assembly language or machine code suitable for the device or computer on which the code can be executed.

Embodiments may also be implemented in cloud computing environments. In this description and the following claims, “cloud computing” may be defined as a model for enabling ubiquitous, convenient, on-demand network access to a shared pool of configurable computing resources (e.g., networks, servers, storage, applications, and services) that can be rapidly provisioned via virtualization and released with minimal management effort or service provider interaction and then scaled accordingly. A cloud model can be composed of various characteristics (e.g., on-demand self-service, broad network access, resource pooling, rapid elasticity, and measured service), service models (e.g., Software as a Service (“SaaS”), Platform as a Service (“PaaS”), and Infrastructure as a Service (“IaaS”)), and deployment models (e.g., private cloud, community cloud, public cloud, and hybrid cloud).

The flow diagrams and block diagrams in the attached figures illustrate the architecture, functionality, and operation of possible implementations of systems, methods, and computer program products according to various embodiments of the present disclosure. In this regard, each block in the flow diagrams or block diagrams may represent a module, segment, or portion of code, which includes one or more executable instructions for implementing the specified logical function(s). It is also noted that each block of the block diagrams and/or flow diagrams, and combinations of blocks in the block diagrams and/or flow diagrams, may be implemented by special purpose hardware-based systems that perform the specified functions or acts, or combinations of special purpose hardware and computer instructions. These computer program instructions may also be stored in a computer-readable medium that can direct a computer or other programmable data processing apparatus to function in a particular manner, such that the instructions stored in the computer-readable medium produce an article of manufacture including instruction means which implement the function/act specified in the flow diagram and/or block diagram block or blocks.

Aspects of the invention described herein enable high-quality inter-frame interpolation of three-dimensional videos that does not require excessive additional computations or excessive computational overheads. In one aspect, a three-dimensional video is defined by the sequence of textured meshes. A three-dimensional video can thus be defined by a sequence of frames F_{N}, where for each frame a mesh M_{N} and a texture T_{N} are defined. We also define as V_{N} a set of vertices of the mesh M_{N}, which can be viewed as a set of k_{N} three-dimensional vectors or as a vector with 3 k_{N} dimensions (where k_{N} is the number of vertices in the mesh M_{N}).

To enable fast frame interpolation, one aspect estimates and stores interpolation parameters at each vertex of the mesh. One of the variants for such parameters is a three-dimensional offset vector. In other embodiments, other variants of the above process, such as the use of higher-order motion models based on velocity vectors and acceleration vectors, or the use of harmonic motion models, can be implemented. The set of offset vectors that includes the set of k_{N} three-dimensional vectors is denoted as O_{N}.

Frame Interpolation with Offset Vectors

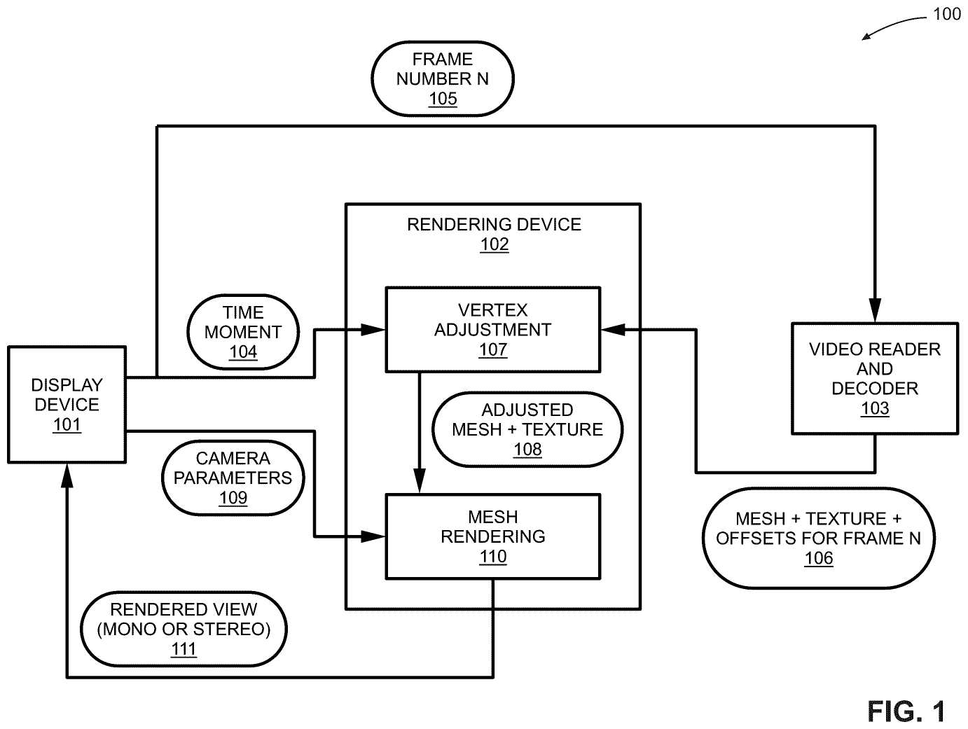

FIG. 1 is a block diagram of a system 100 configured to process and display a three-dimensional video. As depicted, system 100 includes display device 101, rendering device 102, and video reader and decoder 103. Rendering device 102 further includes vertex 107 and mesh rendering 110.

In an aspect, display device 101 (e.g., a virtual reality headset) sends one or more requests to rendering device 102 and video reader and decoder 103. In particular a desired time moment 104 is sent to rendering device 102, and a corresponding frame number N 105 is sent to video reader and decoder 103. In one aspect, the time moment 104 lies in a semi-interval [N, N+1). The discrete-time index N may be associated with a video frame N, while the discrete-time index N+1 may be associated with a video frame N+1.

In one aspect, rendering device 102 then receives the three-dimensional video frame F_{N} (with offsets O_{N}) as data 106, from video reader and decoder 103. In one aspect, the three-dimensional video frame F_{N} includes a mesh and a texture associated with three-dimensional video frame F_{N}. The three-dimensional positions of the vertices V_{N} are then adjusted by vertex adjustment 107 based on the received desired time moment 104 and the offsets O_{N}. Details about the operation of vertex adjustment 107 are described subsequently.

After vertex adjustment 107, the mesh and the texture (which remains unmodified) 108 are sent to the mesh rendering 110 (a rendering process), which also takes into account the desired camera parameters 109 sent by display device 101. For example, for a virtual reality display, the desired camera parameters are based on the position and orientation of the virtual reality headset in the physical space. The rendering process 110 then generates a single two-dimensional view or a stereopair of two-dimensional views 111 of the textured mesh 108 based on the received camera parameters 109. This view or a pair of views 111 are then sent to the display device 101 and output to one or more screens of display device 101.

Embodiments system 100 may be implemented on a processing system comprising at least one processor, a memory, and network connection. Examples of processing systems that can be used to implement neural network architecture include personal computing architectures, microcontrollers, digital signal processors (DSPs), field-programmable gate arrays (FPGAs), cloud computing architectures, embedded processing systems, and so on. For example, any combination of rendering device 102 and video reader and decoder 103 can be implemented on a processing system.

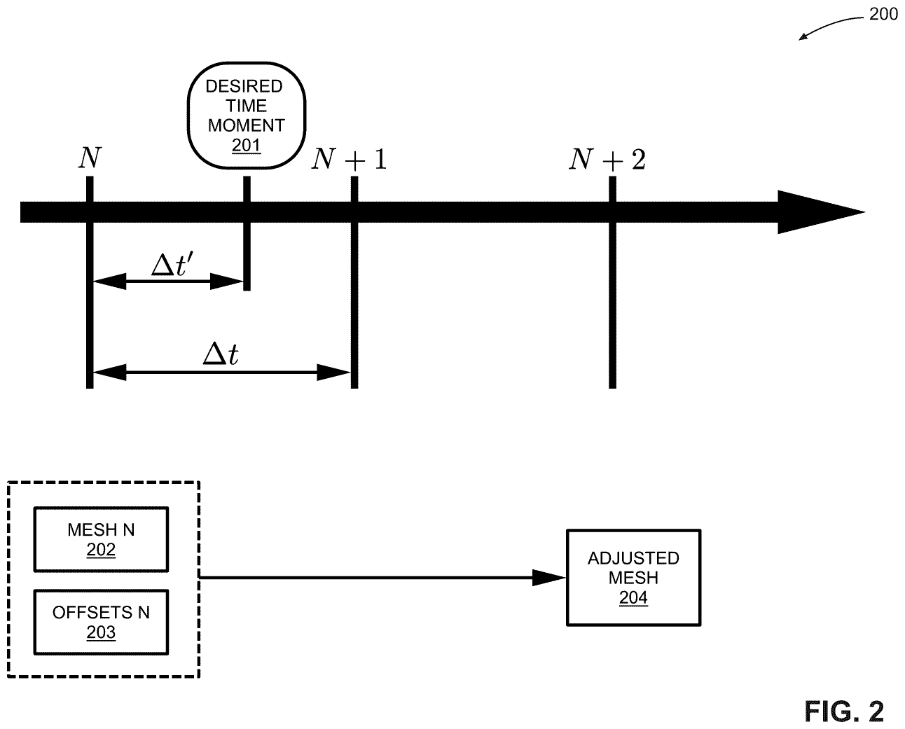

FIG. 2 is a timing diagram 200 associated with a frame interpolation process. Timing diagram 200 depicts a timing flow associated with vertex adjustment 107. In an aspect, vertex adjustment 107 is based on linear interpolation. For example, a ratio τ between a time interval Δt′ from frame N to the desired time moment 201, and a time interval Δt from frame N to frame N+1 is estimated. The vertex offsets O_{N} (e.g., offsets N 203) are then multiplied by the ratio τ and added to the positions of the vertices V_{N} in the mesh M_{N} (e.g., mesh N 202). The resultant mesh with adjusted vertex positions (e.g., adjusted mesh 204) is then passed to the rendering module.

The vertex adjustment step 107 is, in many situations, cheap to compute and is suitable for use at high frame rates or on devices with limited computational power, such as standalone virtual reality headsets.

While the interpolation scheme presented here is based on linear interpolation of the offset vectors, higher-order interpolation schemes taking into account estimated offset vectors at two or more subsequent frames can be potentially used.

### Estimating Offset Vectors

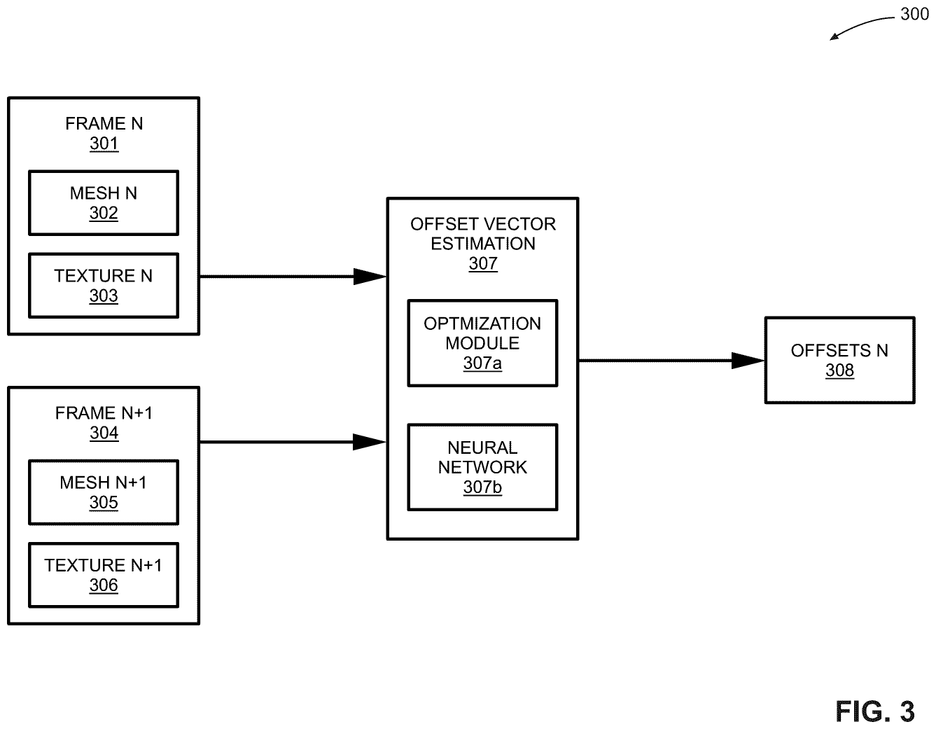

FIG. 3 is a process flow 300 for estimating one or more offset vectors from two subsequent frames (i.e., frame N 301 and frame N+1 304) using an optimization framework. In one aspect, a goal of the estimation procedure 300 is to find one or more offset vectors that make the offset-adjusted mesh model for frame N 301 (i.e., mesh N 302) close to the mesh model for frame N+1 304 (i.e., mesh N+1 305). In an aspect, frame N 301 includes mesh N 302 and texture N 303. Frame 304 may include mesh N+1 305 and texture N+1 306. Frame N 301, frame N+1 305 and their respective contents (including mesh N 302, texture N 303, mesh N+1 305, and texture N+1 306) may be processed by offset vector estimation 307 to generate offsets N 308. Offset vector estimation 307 may be included as a component of rendering device 102.

In one aspect, an offset-adjusted frame N denotes a three-dimensional model defined by frame N 301 once the offsets O_{N} (e.g., offsets N 308) have been added to the vertices of its mesh. The closeness between the offset-adjusted frame N 301 and the frame N+1 304 can be defined in different ways, some of which are defined below.

Given the closeness measure, the offset vectors for frame N can then be estimated using at least two different approaches. In the first approach, an optimization process (e.g., implemented via optimization module 307a) can be initiated and performed over the values of the offset values 308. The optimization objective is the closeness measure, and the optimization is performed by first initializing the values of offsets 308 to random or zero values, and then changing the offset values 308 in order to optimize the closeness measure. As depicted, optimization module 307a may be included in offset vector estimation 307.

In the second approach, the offset vectors O_{N} (308) are predicted by neural network 307b that can have a convolutional or a graph architecture. The neural network 307b can be trained on a dataset of frame pairs, while the training objective for the neural network learning remains the closeness between the offset-adjusted first frame (e.g., frame N 301) in the pair and the second frame (e.g., frame N+1 304) in the pair (averaged over all pairs in the training set as is usual during training of neural networks). As depicted, neural network 307b is included in offset vector estimation 307.

In the third approach, the offset vectors O_{N} (308) are chosen such that their rasterized projections on the two dimensional views of the scene match the optical flow fields between frame N 301 and frame N+1 304 of the scene for those views. The optical flow fields can be computed either for the input video frames or for renderings of the three-dimensional scene reconstructions of frames N 301 and N+1 304.

In an aspect, offset vector estimation 307 may be implemented on a processing system.

### Evaluating the Closeness Between Frames

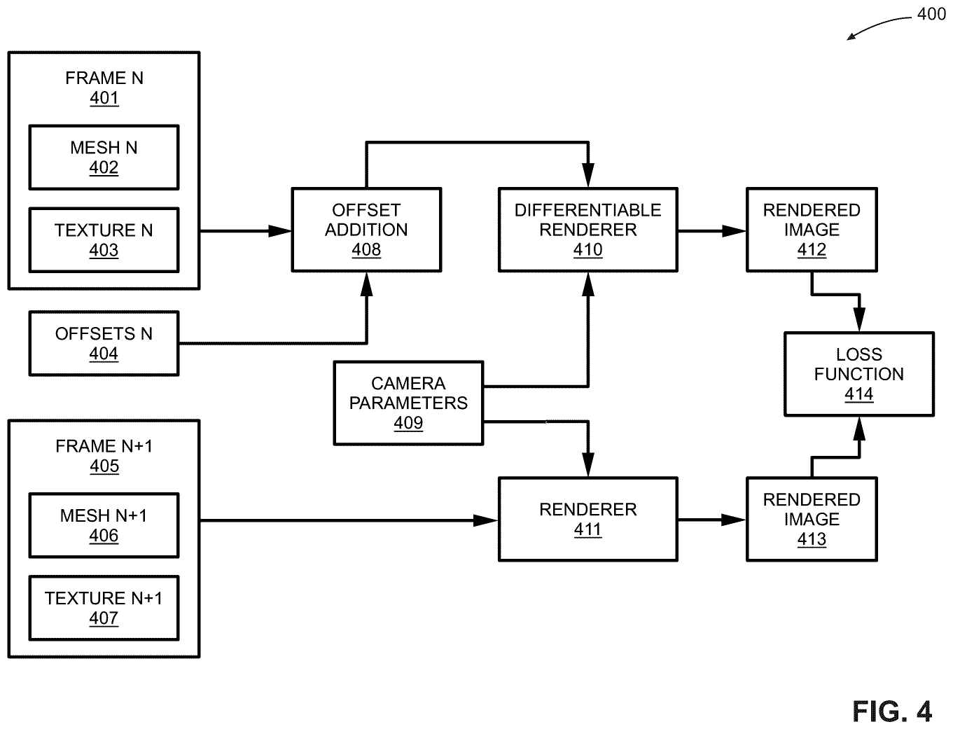

FIG. 4 is a process flow 400 for offset vector estimation based on differentiable rendering. The purpose of frame interpolation is to ensure smooth, jerk-free display of the three-dimensional video. One approach to achieve such a display is to measure a closeness between the offset-adjusted frame N and the subsequent frame N+1 in terms of similarity between the two-dimensional images obtained from the corresponding three-dimensional models. The computation of such closeness measure based on two-dimensional projections is presented in process flow 400.

The said closeness measure takes in the frame N 401 comprising the mesh 402 and the texture N 403, then adjusts the positions of the mesh vertices 408 (i.e., offset addition 408) by adding the offsets 404 to obtain the adjusted model that is received by differentiable renderer 410. As the second three-dimensional model the subsequent frame N+1 405 comprising the mesh N+1 406 with the texture N+1 407 are considered.

Both said three-dimensional models are rendered onto a two dimensional view defined by a camera parameters 409. Different strategies can be used to determine the said camera parameters. For example, these parameters can be taken from a random distribution of cameras pointing towards the three-dimensional scenes. In the case, when the three-dimensional video is reconstructed from multiview-stereo data, the camera parameters 409 can be taken from one of the source cameras in the multiview rig. If the ultimate application implies that the three-dimensional video should be viewed from a limited range of viewpoints, the camera parameters 409 can be sampled from within this range.

The rendering process (e.g., differentiable renderer 410) for the first three-dimensional model produces the two-dimensional rendered image 412, while the rendering process 411 for the second three-dimensional model produces the two-dimensional image 413. Both images are then compared using an image-based loss function 414, which produces the measure of their closeness. Various standard loss functions can be employed for the loss 414. For example, pixel-wise absolute difference, pixel-wise squared difference, perceptual loss functions, etc.

The loss function 414 then serves as the closeness measure. A differentiable renderer can then be used for the rendering process 410 for the offset-adjusted frame N. The use of the differentiable renderer for 410 allows to backpropagate the loss 414 through the computational graph of process flow 400, and to estimate the gradient of the loss 414 with respect to the offset vectors 404. This gradient can then be used within the optimization process 307a or to train the neural network 307b discussed above. The optimization process can take into account both the closeness measure and the optical flow mismatch measure.

Although the present disclosure is described in terms of certain example embodiments, other embodiments will be apparent to those of ordinary skill in the art, given the benefit of this disclosure, including embodiments that do not provide all of the benefits and features set forth herein, which are also within the scope of this disclosure. It is to be understood that other embodiments may be utilized, without departing from the scope of the present disclosure.

What is claimed is:

1. A method for displaying a three-dimensional video comprising a plurality of frames, at a different frame rate from which the video was stored or acquired, the method comprising:
receiving, at a video reader and decoder, a frame N corresponding to a frame number N in the video;
retrieving, at the video reader and decoder, a 3D mesh including a plurality of vertices, a texture, and one or more offset vectors associated with each vertex of the 3D mesh in the frame N;
transmitting, to a rendering device, the 3D mesh, the texture, and the offset vectors associated with the frame N;
adjusting, at the rendering device, at least one vertex of the 3D mesh according to the corresponding offset vectors and a playback time moment, wherein the playback time moment is between N and N+1, wherein N+1 is a frame number corresponding to a frame N+1 immediately following the frame N in the video; and
rendering the adjusted 3D mesh and the texture according to one or more camera parameters associated with a display device, wherein the display device is configured to display the video.

2. The method of claim 1, wherein the retrieving the offset vector further comprises:
substantially optimizing a closeness measure between the frame N and the frame N+1; and
determining the offset vectors based on the substantially optimized closeness measure.

3. The method of claim 1, wherein the retrieving the offset vectors further comprises:
determining a closeness measure between frame N and frame N+1 via a neural network; and
determining the offset vectors based on the determined closeness measure.

4. The method of claim 1, wherein the retrieving the offset vectors further comprises:
determining one or more offset vectors such that rasterized projections on a set of two-dimensional views of a scene in the video match one or more optical flow fields between the frame N and the frame N+1 of the scene for the two-dimensional views.

5. The method of claim 1, further comprising:
comparing a rendered image of offset-adjusted frame N, defined as the frame N after the adjusting, with a rendered image of the frame N+1;
computing a loss function based on the comparison; and
adjusting the offset vectors based on the loss function.

6. The method of claim 5, wherein the method further comprises using the computed loss function for training a neural network that is used to predict the offset vectors.

7. A system for displaying a three-dimensional video comprising a plurality of frames, at a different frame rate from which the video was stored or acquired, the system comprising:
a video reader and decoder configured to receive a frame N corresponding to a frame number N in the video;
the video reader and decoder further configured to retrieve a 3D mesh including a plurality of vertices, a texture and one or more offset vectors associated with each vertex of the 3D mesh in the frame N, and transmit, to a rendering device, the 3D mesh, the texture, the and offset vectors associated with the frame N;
the rendering device configured to adjust all vertices of the 3D mesh according to the corresponding offset vectors and a playback time moment, wherein the playback time moment is between N and N+1, wherein N+1 is a frame number corresponding to a frame N+1 immediately following the frame N in the video; and
the rendering device configured to rendering the adjusted 3D mesh and the texture according to camera parameters associated with a display device, wherein the display device is configured to display the video.

8. The system of claim 7, wherein the retrieving the offset vector further comprises:
substantially optimizing a closeness measure between the frame N and the frame N+1; and
determining the offset vectors based on the substantially optimized closeness measure.

9. The system of claim 7, wherein the retrieving the offset vectors further comprises:
determining a closeness measure between frame N and frame N+1 via a neural network; and
determining the offset vectors based on the determined closeness measure.

10. The system of claim 7, wherein the retrieving the offset vectors further comprises:
determining one or more offset vectors such that rasterized projections on a set of two-dimensional views of a scene in the video match one or more optical flow fields between the frame N and the frame N+1 of the scene for the two-dimensional views.

11. The system of claim 7, further comprising:
comparing a rendered image of offset-adjusted frame N, defined as the frame N after the adjusting, with a rendered image of the frame N+1;
computing a loss function based on the comparison; and
adjusting the offset vectors based on the loss function.

12. The system of claim 11, wherein the method further comprises using the computed loss function for training a neural network that is used to predict the offset vectors.

13. A machine-readable storage medium storing a set of instructions that are executable by one or more processors of a system, video reader and decoder, and a rendering device for displaying a three-dimensional video at a different frame rate from which the video was stored or acquired, wherein the set of instructions is configured to perform the method of claim 1.

14. A method for training a neural network for offset vectors determination, the method comprising:
comparing a rendered image of an offset-adjusted mesh of a frame N corresponding to a frame number N in a video further comprised of a plurality of frames, with a rendered image of the mesh of a frame N+1 corresponding to a frame number N+1 in the video;
computing a loss function based on the comparing; and
training a neural network used to predict the offset vectors with the loss function.

15. A machine-readable storage medium storing a set of instructions that are executable by one or more processors of a system for training a neural network for offset determination, wherein the set of instructions are configured to perform the method of claim 14.

16. The method of claim 1, wherein the playback time interval between N and N+1 is a semi-interval [N, N+1).

17. The method of claim 1, wherein the display device is a virtual reality headset.

18. The system of claim 7, wherein the display device is a virtual reality headset.

19. The system of claim 7, wherein the playback time interval between N and N+1 is a semi-interval [N, N+1).

20. The method of claim 1, wherein the three-dimensional video is constructed from any of a random distribution of cameras pointing towards one or more three-dimensional scenes, and multiview-stereo data.
